(19) United States
(12) Patent Application Publication
(10) Pub. No.: US 2012/0228461 A1
(43) Pub. Date: Sep. 13, 2012

(54) Antenna Mast Arrangement

(75) Inventor: Jan Angseryd, Taby (SE)

(73) Assignee: TELEFONAKTIEBOLAGET LM ERICSSON (PUBL), Stockholm (SE)

(21) Appl. No.: 13/509,192

(22) PCT Filed: Nov. 13, 2009
(86) PCT No.: PCT/EP09/65140

§ 371 Date: May 10, 2012

(51) Int. Cl. H01Q 1/12

(52) U.S. Cl. 248/513

(57) ABSTRACT

There is provided a top section (6) for attachment at an upper end of an antenna mast body (4), wherein the top section (6) or the antenna mast body (4) comprises an attachment structure (24), to which at least one antenna is connectable. The top section (6) comprises at least two discrete contour elements (14, 16) defining an outer contour of the top section (6) as viewed in a horizontal direction. The contour elements (14, 16) extend in a direction comprising a vertical component. The at least one antenna, when connected to the attachment structure (24), is arranged between the contour elements (14, 16). An antenna mast arrangement (2) comprising such a top section (6) and antenna mast body is also provided.

### TECHNICAL FIELD

The present invention relates to a top section for attachment at an upper end of an antenna mast body, and an antenna mast arrangement. The present invention is generally applicable in connection with telecommunication masts, and in particular applicable to an antenna tower structure for use in a wireless communications system.

### BACKGROUND

An antenna mast for a wireless communication system is provided with one or more antennas at its upper end. The antennas may be of one type only or of different types and may be adapted to perform different functions in the wireless communication system. Examples of such functions may be communication between a mobile communication device and a radio base station arranged in or at an antenna mast, and communication between a radio base station in or at a relevant antenna mast and a radio base station at a different location than the relevant antenna mast.

Antenna masts may be constructed using different techniques, examples are: steel lattice masts, masts comprising one or more steel tubes and masts comprising one or more reinforced concrete tubes. Accordingly, the expression “antenna mast” is intended to encompass antenna masts with an open structure, such a lattice, as well as masts with a closed structure such as a tubular mast, e.g. in the form of a tower.

The antennas at the top end of an antenna mast may be arranged fully visible or enclosed in a so-called radome. A radome may conceal the antennas from public view and accordingly prevent theft and damages of the antennas. A radome may also protect the antennas against influences of weather to a certain extent. A radome may be made from a glass fibre enforced material.

WO 2007/108766 discloses an antenna tower structure comprising an elongated tower body made from reinforced concrete. Inside the tower body at an upper end a radio base station is arranged. On top of the elongated tower body there is arranged an antenna covered by a radome. In practice, the antennas may be attached to a steel bar construction at the top of the elongated tower body. The steel bar construction is covered with sheets of fabric material forming an enclosing radome.

DE 20 2005 010 140 U1 discloses an antenna construction wherein the antennas at the top of the construction are arranged inside an outer shell made from a material permeable to radio waves in the range of the antennas. A problem is that, depending on frequency and wave length of the radio waves, different materials have different permeability.

### SUMMARY

A general object of the present invention is to provide an alternative solution for a top section of an antenna mast, which prevents clear view of the antennas from a ground level.

According to an aspect of the invention, the object is achieved by a top section for attachment to an upper end of an antenna mast body, wherein the top section or the antenna body comprises an attachment structure, to which at least one antenna is connectable. The top section comprises at least two discrete contour elements defining an outer contour of the top section as viewed in a horizontal direction when the top section is attached to the upper end of the antenna mast body. The contour elements extend in a direction comprising a vertical component. The at least one antenna, when connected to the attachment structure, is arranged between and radially within the contour elements.

Since the contour elements provide a distinct contour of the top section when arranged at an upper end of an antenna mast, the impression that is made on a viewer from ground level is that formed by the contour elements, which still adequately conceal an antenna when viewed from ground level. At the same time the antenna is not impeded in its performance. As a result, the above mentioned object is achieved.

The antenna being arranged between and radially within the contour elements results in that the contour elements of the antenna form an outer contour of the top section and not any portion of the antenna. Put differently, each contour element forms an outer peripheral contour portion of the top section. The term “radially within” applies to top sections with a round as well as a polygonal cross sectional shape. The contour elements being discrete means that they each are separate parts.

According to example embodiments the top section may comprise a roof section and the at least two discrete contour elements may adjoin the roof section. By means of a roof section the outer contour of the top section may be further accentuated. Accordingly, antennas at an upper end of an antenna mast may be arranged beneath the roof section and thus, concealed or at least not clearly distinguishable when viewed from ground level. The roof section may comprise a closed roof or a roof with an open structure, such as a mesh structure.

According to example embodiments the at least two discrete contour elements may each extend in a substantially vertical plane.

According to example embodiments the at least two contour elements may comprise a first wall section extending in a first substantially radial direction of the top section and a second wall section extending in a second substantially radial direction of the top section such that an edge portion of each of the wall sections defines the said outer contour. The first and second wall sections may for instance be attached to the attachment structure. A radial direction is a direction along an axis intersecting a centre axis of the top section and/or the antenna mast body.

According to example embodiments the at least one antenna, when connected to the attachment structure, may be arranged between the first wall section and the second wall section. Again, when viewed form ground level the antenna will not be clearly distinguishable when it is arranged between the first and second wall sections.

According to example embodiments at least one of the first and the second wall sections may be at least partially permeable to air in order to reduce wind resistance of the top section. Such permeability may be achieved by means of the walls or at least portions of the walls comprising a mesh structure. Alternatively, the walls may be provided with openings or recesses, through which air may pass.

According to example embodiments the at least two contour elements may each comprise a wire or may have an elongated form similar to a wire. Such wires or similar elements may form the said outer contour. For example, there may be provided several wires distributed around the periphery of the top section to form a desired outer contour of the top section. One or more wires may be arranged in front of a particular antenna but there will be at least two wires, which are not arranged in front of that particular antenna, which then will be arranged between those two wires.

According to example embodiments the top section may comprise a lower level which is adapted to comprise at least one antenna of a first type, and an upper level which is adapted to comprise at least one antenna of a second type. The antennas of the first type and the second type respectively, each may be matched for specific a purpose.

According to example embodiments the top section may comprise a lower module at the lower level and an upper module at the upper level. The lower module may comprise a first circle sector which is adapted to comprise the at least one antenna of the first type and the upper module may comprise a second circle sector which is adapted to comprise the at least one antenna of the second type. The upper module may be displaceable in a circumferential direction in relation to the lower module. In this manner antennas at the upper level may easily be distributed and pointed in directions different than antennas at the lower level. There may be a horizontal partition arranged between the lower and upper modules, e.g. in the form of a roof on the lower module.

According to example embodiments at least one of the contour elements may extend over the lower level only or over the upper level only. In this manner an outer contour at the lower level or the upper level is defined by means of the contour element.

According to example embodiments the at least one of the contour elements may extend over the lower level and the upper level. In this manner an outer contour is defined over both levels by one contour element. Contour elements of different lengths and shapes may be used in combination around the top section.

According to example embodiments the top section may comprises at least one discrete outline element extending substantially horizontally to define an outer contour of the top section. In combination with the contour elements such a substantially horizontally arranged outline element may further emphasis the outer contour of the top section. When viewed from ground level, the outline element may further define an outer contour of the top section and make antennas even more difficult to distinguish.

According to example embodiments, the outline element may extend between the first and second wall sections and radially outside the at least one antenna when connected to the attachment structure. For instance the outline element may have a curved shape. Several outline elements may be arranged to extend between the wall sections. A vertical distance between the outline elements ensures that an antenna is not impeded in its performance by the outline elements.

According to example embodiments the contour elements and/or outline element may be illuminated. Such illumination may emphasis the contour elements and/or the outline element and therefore make the antennas difficult to distinguish. Illumination may be achieved by one or more light sources, which may be arranged in, on or near the top section or a relevant antenna mast. Examples of possible light sources include laser light, spot lights or lamps provided with a light bulb, halogen lamp or fluorescent tube.

According to example embodiments the contour elements and/or the outline element may be provided with heating means for reducing ice and/or water collected on the contour elements and/or the outline element. Such heating means may for instance comprise electrically heated wires or plates or fans distributing heated air.

According to example embodiments the top section may comprise a plurality of contour elements distributed circumferentially around the top section. in this manner the said outer contour of the top section may be further emphasised. For example several wall sections may be arranged around the top section or there may be arranged a plurality of wires around the top section.

According to example embodiments the said outer contour of the top section may have a shape of a truncated cone with its narrow end adapted to adjoin the antenna mast body.

According to an aspect of the invention there is provided an antenna mast arrangement, comprising an antenna mast body and a top section as mentioned above at an upper end of the antenna mast body.

According to example embodiments the antenna mast body or the top section may comprise an attachment structure, to which at least one antenna is connected. Such an attachment structure may be arranged centrally at an upper end of the antenna mast arrangement. The attachment structure may have a smaller diameter than the antenna mast body. The attachment structure may form an extension of the antenna mast body.

According to example embodiments the antenna mast arrangement may be a tubular telecommunication tower and the antenna mast body may be made from reinforced concrete.

Aspects of the invention include an attachment structure.

Further features of, and advantages with, the present invention will become apparent when studying the appended claims and the following description. Those skilled in the art will realize that different features of the present invention may be combined to create embodiments other than those described in the following, without departing from the scope of the present invention, as defined by the appended claims.

### BRIEF DESCRIPTION OF THE DRAWINGS

The various aspects of the invention, including its particular features and advantages, will be readily understood from the following detailed description and the accompanying drawings, in which:

FIG. 1 illustrates schematically an antenna mast arrangement according to example embodiments,

FIG. 2 illustrates schematically a top view of a cross section of the top section,

FIG. 3 illustrates schematically a section through an upper end of an antenna mast arrangement according to example embodiments,

FIGS. 4-6 illustrate schematically upper ends of antenna mast arrangements according to example embodiments, and

FIG. 7 illustrates schematically an attachment arrangement at an upper end of an antenna mast arrangement according to example embodiments.

### DETAILED DESCRIPTION

The present invention will now be described more fully with reference to the accompanying drawings, in which example embodiments are shown. However, this invention should not be construed as limited to the embodiments set forth herein. Disclosed features of example embodiments may be combined as readily understood by one of ordinary skill in the art to which this invention belongs. Like numbers refer to like elements throughout.

As used herein, the term “comprising” or “comprises” is open-ended, and includes one or more stated features, elements, steps, components or functions but does not preclude the presence or addition of one or more other features, elements, steps, components, functions or groups thereof.

As used herein, the term “and/or” includes any and all combinations of one or more of the associated listed items.

As used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est,” may be used to specify a particular item from a more general recitation.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present.

Well-known functions or constructions may not be described in detail for brevity and/or clarity.

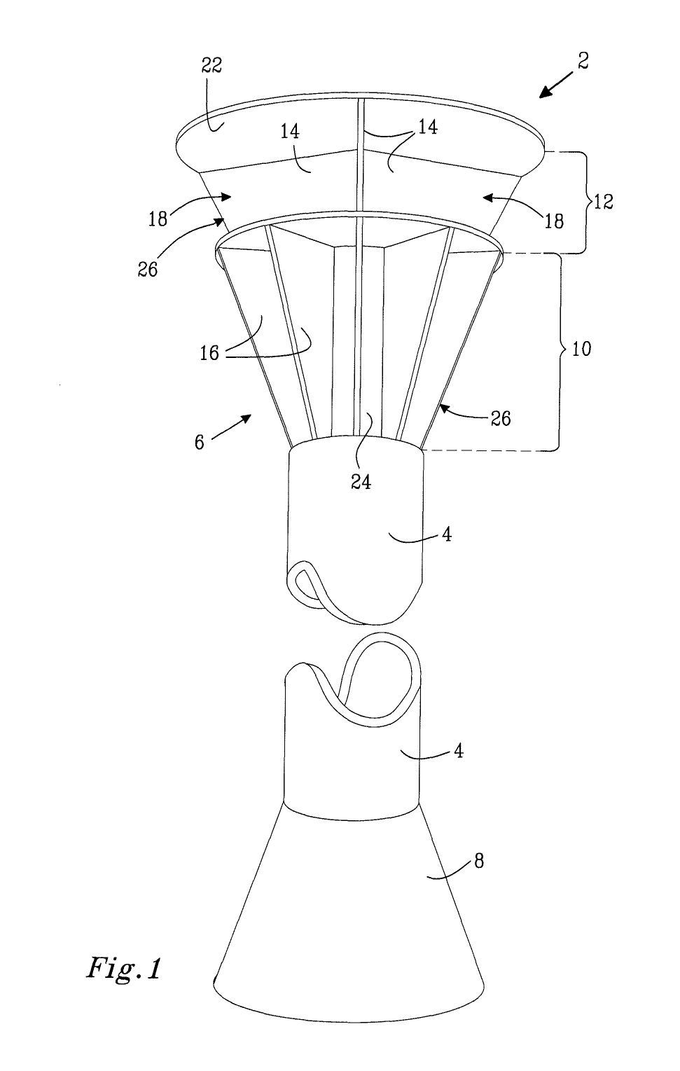

FIG. 1 illustrates schematically an antenna mast arrangement 2 according to example embodiments and comprises an antenna mast body 4 and a top section 6. The antenna mast body 4 has a tubular form and may be manufactured from reinforced concrete. Accordingly, the antenna mast arrangement 2 is a tubular telecommunication tower. Inside the antenna mast body 4 there may be arranged at least one radio base station of a wireless communication system. The radio base station may be arranged at an upper end of the antenna mast body 4. The top section 6 is adapted for carrying at least one antenna of the wireless communication system. The antenna body 4 may at its lower end be provided with an opening providing access to an inside of the antenna mast arrangement 2. At its lower end the antenna body 4 has a shape of a truncated cone 8. At an upper end of the antenna mast arrangement 2 the top section 6 has a shape of an inverted truncated cone. Other shapes of the antenna mast arrangement 2 than illustrated in FIG. 1 are also envisaged.

Purely by way of example, the antenna mast body 4 at a mid portion with uniform diameter may have a diameter of 1,8 meters and a total height of the antenna mast arrangement 2 may be 40 meters. Other dimensions are of course foreseen.

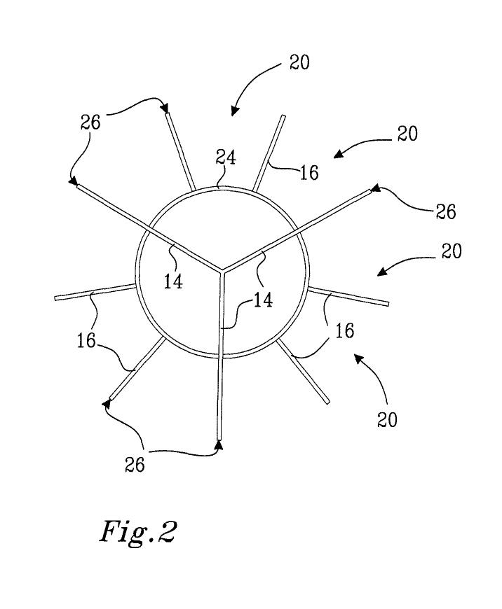

In addition to FIG. 1 reference is made to FIG. 2, which illustrates schematically a top view of a cross section of the top section 6. The top section 6 comprises a lower module 10 at a lower level of the top section 6 and an upper module 12 at an upper level of the top section 6. Further, the top section 6 comprises a number of discrete contour elements in the form of wall sections 14, 16 extending in radial directions of the top section 6. Three wall sections 14 of a first type extend substantially vertically over substantially the entire top section 6 through both the lower and the upper modules 10, 12. The lower module 10 comprises six wall sections 16 of a second type, which extend substantially vertically. The wall sections 14 of the first type define circle sectors 18 of the upper module 12. The wall sections 14, 16 of the first type and the second type define circle sectors 20 of the lower module 10. At an uppermost end of the top section 6 there is arranged a roof section 22.

One or more of the wall sections 14, 16 or portions of the wall sections 14, 16 may be formed from a wire mesh or other structure which may reduce wind resistance of the top structure 6.

The top section 6 comprises a centrally arranged attachment structure 24. Alternatively, the attachment structure 24 may form part of the antenna mast body 4. In any case the attachment structure 24 is adapted for supporting antennas of the wireless communication system and may also be adapted for supporting the wall sections 14, 16. One or more antennas may be arranged in each of the circle sectors 18, 20.

The contour elements in the form of wall sections 14, 16, more specifically outer edge portions 26 of the wall sections 14, 16, define an outer contour of the top section 6. When viewed in a horizontal direction and also when viewed from ground level at a distance from the antenna mast arrangement 2, the contour defined in example embodiments may have the form of an inverted truncated cone. The antennas of the wireless communication system arranged in the circle sectors 18, 20 will, at least from some directions, not extend outside the outer edge portions 26. Also the roof section 22 will contribute in defining an outer contour of the top section 6. Accordingly, from a distance antennas arranged in the circle sectors 18, 20 are difficult to distinguish.

The top section 6 may be manufactured as a separate entity, which is attached to the antenna mast body 4. As mentioned above, the attachment structure 24 may form part of either the top section 6, in which case it is attached to the antenna mast body 4 together with the top section 6, or it may form part of the antenna mast body 4, in which case the top section 6 may at least at some points be attached to the attachment structure 24.

According to example embodiments (not shown in the figures), the top section 6 may instead be seen as two separate modules, the upper and lower modules 10 and 12, respectively. In such embodiments, there may be for instance three wall sections of a first type, which extend substantially vertically in the upper module 12 only, from the roof section 22 to the lower module 10. Additionally, or alternatively, the lower module 10 may comprise for instance nine wall sections of a second type, which extend substantially vertically within the lower module 10 only. Thus, the three wall sections of the first type in the upper module 12 do not necessarily coincide with three of the wall sections of the lower module 10. However, it may be advantageous if the three wall sections of the first type in the upper module 12 do coincide with three of the wall sections of the lower module 10, as similar to embodiments illustrated in FIGS. 1 and 2. This may give the top structure a comparatively better structural strength.

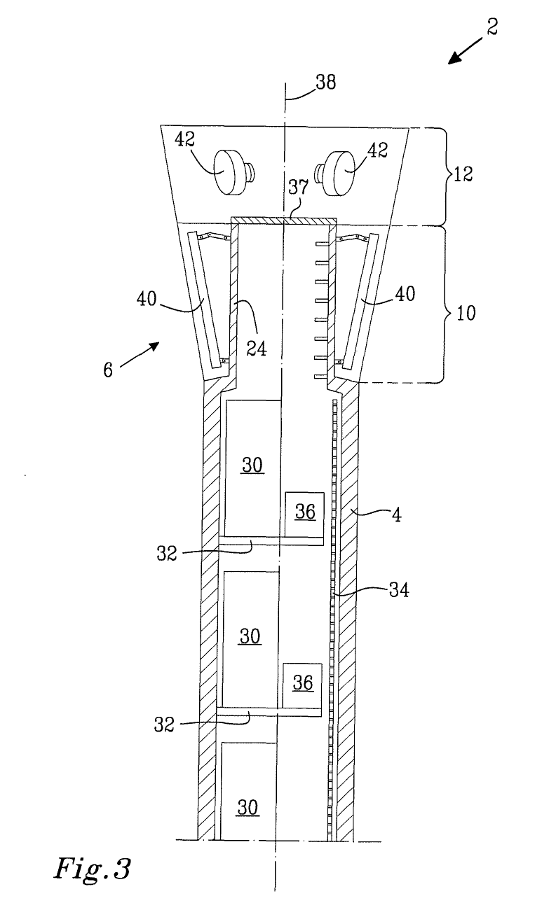

FIG. 3 illustrates schematically a section through an upper end of an antenna mast arrangement 2 according to example embodiments. Inside an antenna mast body 4 of the antenna mast arrangement 2 there are arranged, e.g., three radio base stations 30 on separate floor sections 32. Service personnel may reach the radio base stations 30 by climbing a ladder 34. Doors 36 in the floor sections 32 provide access to each floor section 32 and a relevant radio base station 30. At its upper end the antenna mast body 4 comprises an attachment structure 24. The attachment structure 24 has an upper door 37 which may be opened such that service personnel may access the top section 6. Around the attachment structure 24 there is arranged a top section 6 of the antenna mast arrangement 2. Schematically, an outer contour of the top section 6 is illustrated as defined by wall sections extending in a substantially radial direction from a centre axis 38 of the antenna mast arrangement 2. Again the outer contour is that of an inverted truncated cone.

Antennas 40 of a first type are arranged at a lower level of the top section 6. Antennas 42 of a second type are arranged at an upper level of the top section 6. At the upper level the top section 6 comprises an upper module 12 which may be displaced by turning in relation to the lower level of the top section 6, i.e. the upper module 12 is displaceable in a circumferential direction. The lower level of the top section 6 may comprises a lower module 10.

In FIG. 3, service personnel may reach the radio base stations 30 by climbing a ladder 34 as described above. However, it should be appreciated that, in other embodiments, service personal may reach the radio base stations 30 by using a lifting arrangement (not shown in the figures), such as an elevator or the like.

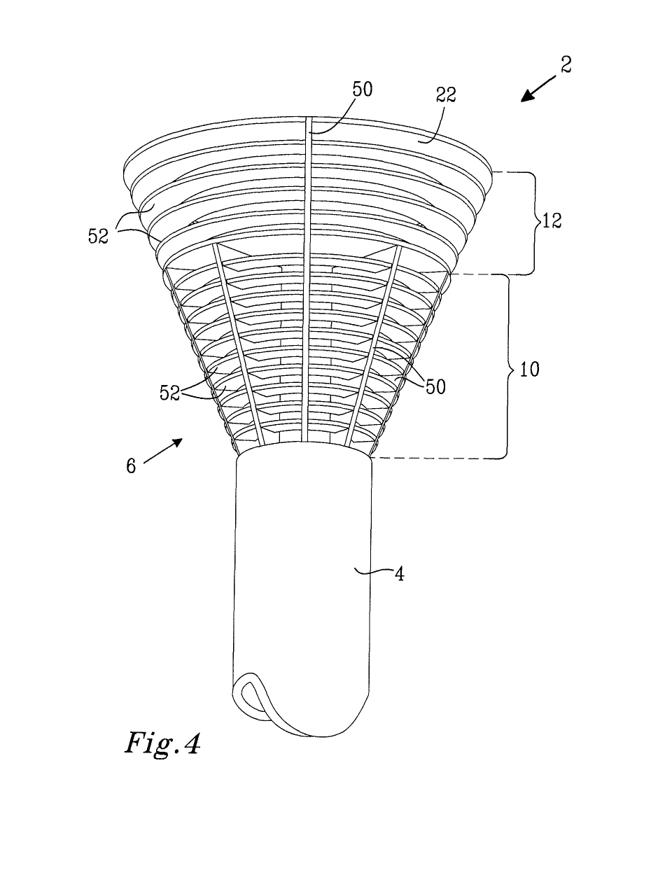

FIG. 4 illustrates schematically an upper end of an antenna mast arrangement 2 according to example embodiments. A top section 6 of the antenna mast arrangement 2 is provided with discrete contour elements in the form of wall sections 50, which may extend substantially vertically over the total height of a lower module 10 and an upper module 12 and/or one or more of the wall sections 50 may extend over the height of one of the modules 10, 12 only. The wall sections 50 delimit circle sectors of the modules 10, 12, which are adapted to house antennas of a wireless communication system.

In addition to the wall sections 50, the top section 6 is provided with a roof section 22 and discrete outline elements 52. The outline elements 52 extend in a substantially horizontal direction between the wall sections 50. Alternatively the outline elements 52 may extend at an inclined angle between the wall sections 50. The outline elements 52 are arc-shaped such that an antenna may be arranged in a circle sector of a module 10, 12 with one or more outline elements 52 extending outside the antenna. Together the wall sections 50, the roof section 22 and the outline elements 52 define an outer contour of the top section 6. The wall sections 50, the roof section 22 and the outline elements 52 make antennas arranged in the top section 6 difficult to distinguish when viewed from ground level. The distance between the individual outline elements 52 may be wider or narrower than illustrated in FIG. 4.

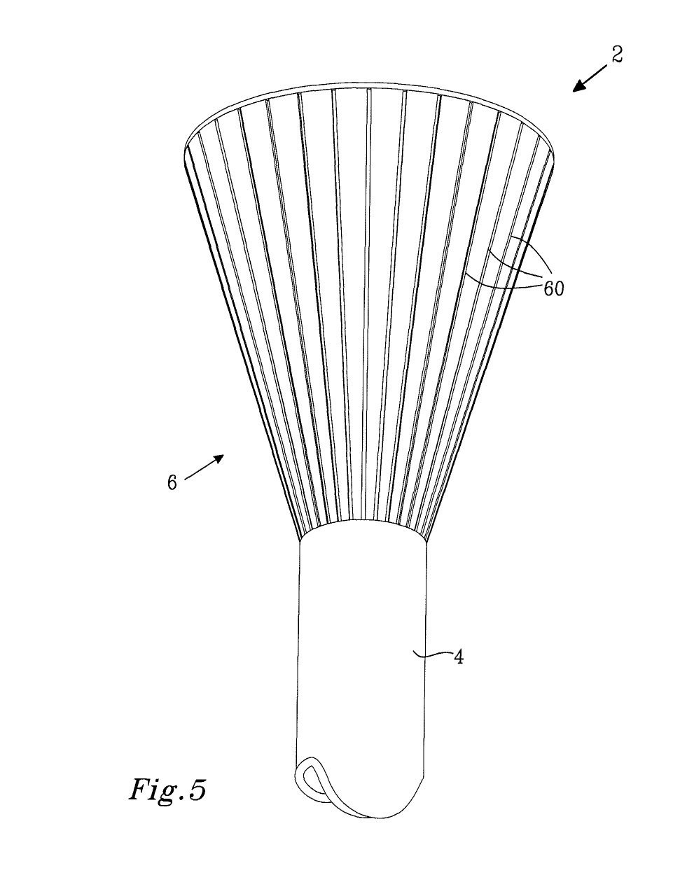

FIG. 5 illustrates schematically an upper end of an antenna mast arrangement 2 according to example embodiments. A top section 6 of the antenna mast arrangement 2 is provided with discrete contour elements in the form of wires 60. A Plurality of wires 60 extend from a bottom portion of the top section 6 to a top portion of the top section 6. The number of wires 60 may be selected as desired. For instance there may be any number of wires between 2-500 wires 60 arranged around the top section 6. Together the wires 60 define an outer contour of the top section 6. The wires 60 make antennas arranged in the top section 6 difficult to distinguish when viewed from ground level. The wires 60 may be illuminated e.g. from below by means of one or more non-shown lamps. It may also be possible to illuminate the wires 60 by means of light loops running along one or LED-based lighted beads running along one or more of the wires 60. The distance between the individual wires 60 may be wider or more narrow than illustrated in FIG. 5.

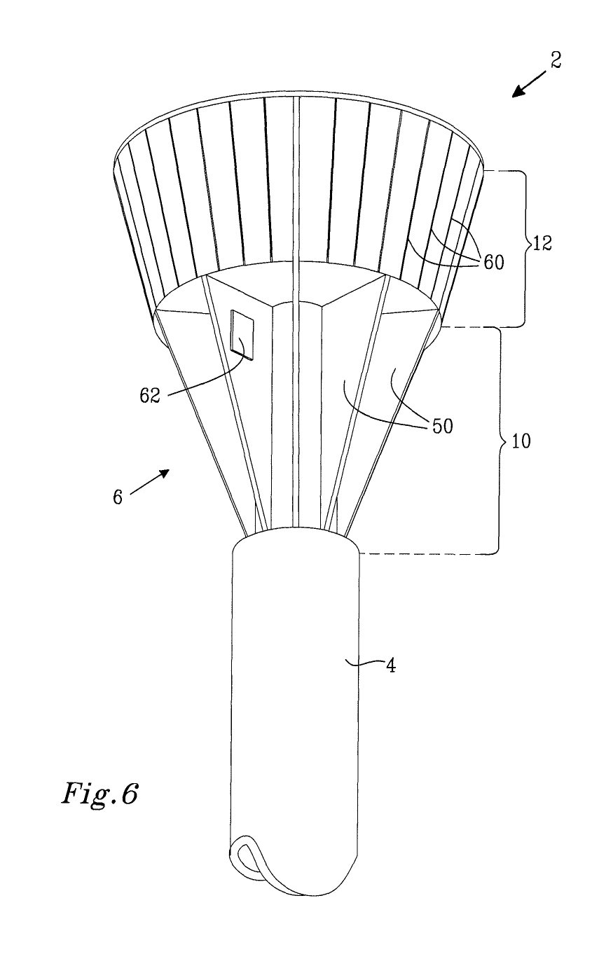

FIG. 6 illustrates schematically an upper end of an antenna mast arrangement 2 according to example embodiments. A top section 6 of the antenna mast arrangement 2 is provided with discrete contour elements in the form of wall sections 50 and wires 60. A lower module 10 of the top section 6 comprises wall sections 50. An upper module 12 of the top section 6 comprises wires 60. Optionally, some or all of the wall sections 50 may extend over the lower module 10 and the upper module 12. Alternatively or in addition, the upper module 12 may comprise separate wall sections extending substantially vertically in the upper module 12 only. Together the wall sections 50 and the wires 60 define an outer contour of the top section 6. The wall sections 50 and the wires 60 make antennas arranged in the top section 6 difficult to distinguish when viewed from ground level. The wall sections 50 and/or the wires 60 may be provided with heating means for reducing ice and/or water collected on the wall sections 50 and/or the wires 60. A heating element in the form of an electrically heated plate 62 is arranged on one of the wall sections 50.

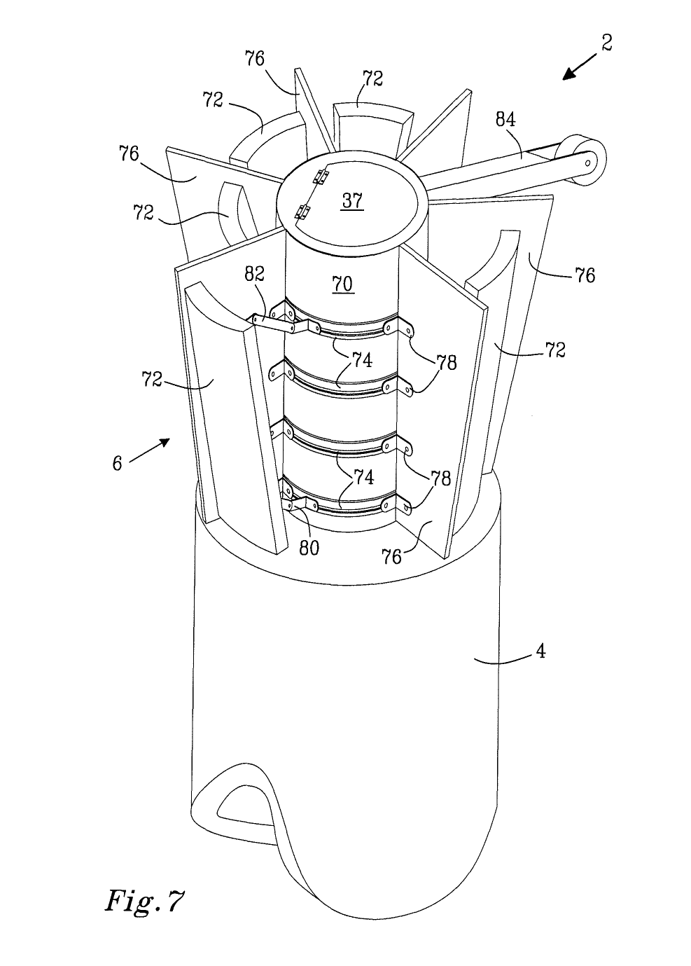

FIG. 7 illustrates schematically an attachment structure 24 at an upper end of an antenna mast arrangement 2 according to example embodiments. The attachment structure 24 may comprise a tubular section 70. A circular tube is illustrated in FIG. 7 however a polygonal tube may alternatively be used.

According to example embodiments an inside of the tubular section 70 may comprise internal steps, a ladder or similar climbing arrangement. The climbing arrangement may facilitate service personnel to climb through the attachment structure 24.

According to example embodiments, at an upper end of the attachment structure 24 there may be arranged a door 37. The door 37 may be arranged horizontally as illustrated or it may alternatively be arranged vertically.

According to example embodiments the attachment structure 24 may comprise an attachment arrangement adapted for attaching one or more antennas 72 to the attachment structure 24 and the antenna mast arrangement 2. The attachment arrangement may also be adapted for attaching one or more contour elements 76 to the attachment structure 24 and the antenna mast arrangement 2.

According to example embodiments the attachment arrangement may comprise one or more rails 74 extending at least partially around the attachment structure 24. The antennas 72 and/or the contour elements 76 may engage directly with the one or more rails 74. Alternatively or in combination with direct engagement, the attachment arrangement may comprise brackets 78, 80, 82 for connecting one or more antennas 72 and/or one or more contour elements 76 to the attachment structure 24 and the antenna mast arrangement 2. The one or more rails 74 may for instance have a C-shaped, T-shaped or L-shaped cross section. The brackets may be of various types, including a fixed bracket 78 which permits movement of an attached part in a circumferential direction when the fixed bracket 78 is arranged in/on the rail 74 before the bracket has been tightened to the rail 74; a hinged bracket 80 which permits pivoting of an attached part in addition to the above mentioned movement in the circumferential direction, and a linked bracket 82 which permits adapting a distance between an attached part and the rail 74 in addition to the above mentioned movement in the circumferential direction.

Since the one or more rails 74 extend at least partially around the attachment structure 24, the one or more antennas 72 and/or the one or more contour elements 76 may be displaced in a circumferential direction around the attachment structure 24. Accordingly, the one or more antennas 72 may be arranged as required by local conditions at a site of an antenna mast arrangement 2. Also, the one or more contour elements 76 may be arranged circumferentially as desired to provide an upper end of the antenna mast arrangement 2 with a desired contour. Also, replacing of the contour elements 76 with differently shaped contour elements is easily done.

By means of the different types of brackets 78, 80, 82, the one or more antennas 72 and/or the one or more contour elements 76 may be attached in suitable positions on the one or more rails 74. For instance an antenna 72 may be tilted at a desired angle by using a linked bracket 82 at an upper portion of the antenna 72 and a hinged bracket 80 at a lower portion of the antenna 72.

According to example embodiments the attachment structure 24 may comprise a lifting device 84 adapted to lift devices and/or utensils on an outside of the antenna mast arrangement 2. The lifting device 84 may be foldable or telescopic such that it may be retracted towards the attachment structure 24 when it is not being used.

According to example embodiments the attachment structure 24 may form part of a top section of the antenna mast arrangement 2. Alternatively the attachment structure 24 may form part of an antenna mast body 4 of the antenna mast arrangement 2, or the attachment structure 24 may be a separate part, which may be attached to the antenna mast body 4.

Example embodiments may be combined as understood by a person skilled in the art. It is also understood by those skilled in the art that a top section may comprise only one level or only one module. Similarly, a top section may comprise more than two levels and more than two modules. For instance, there may be three levels and two modules wherein a lower module may comprise two levels and an upper module forms one level, or there may be four levels wherein each level comprises one module, etc. The outer contour of the top section may be of many other forms than an inverted truncated cone, e.g. square, circular cylindrical, polygonal cylindrical, round etc. The plurality of contour elements distributed circumferentially around the top section may for example comprise: nine wall sections around the top section, or nine wall sections around the top section at the lower level and three wall sections at the upper level, or a plurality of wires around the top section, each wire extending in a direction comprising a vertical component, or a number of wall sections at the lower level and a plurality of wires around the top section at the upper level. Not only contour elements in the form of wires may be illuminated but also other types of contour elements, e.g. wall sections or edge portions of wall sections.

Even though the invention has been described with reference to example embodiments, many different alterations, modifications and the like will become apparent for those skilled in the art.

Therefore, it is to be understood that the foregoing is illustrative of various example embodiments and is not to be limited to the specific embodiments disclosed and that modifications to the disclosed embodiments, combinations of features of disclosed embodiments as well as other embodiments are intended to be included within the scope of the appended claims.

1-35. (canceled)

36. An antenna mast arrangement, comprising an antenna mast body and a top section arranged at an upper end of said antenna mast body, wherein either said top section or said antenna mast body comprises an attachment structure to which a plurality of antennas are connectable, wherein said top section comprises a lower level that is adapted to comprise at least one antenna of a first type, and an upper level that is adapted to comprise at least one antenna of a second type, wherein said top section further comprises at least two discrete contour elements defining an outer contour of said top section as viewed in a horizontal direction when said top section is attached to said upper end of said antenna mast body, wherein said contour elements extend in a direction comprising a vertical component, and wherein said at least one antenna of the first type and said at least one antenna of the second type, when connected to said attachment structure, are arranged between and radially within said contour elements.

37. The antenna mast arrangement of claim 36, wherein said top section comprises a roof section and said at least two discrete contour elements adjoin said roof section.

38. The antenna mast arrangement of claim 36, wherein said at least two contour elements comprise a first wall section extending in a first substantially radial direction of said top section and a second wall section extending in a second substantially radial direction of said top section such that an edge portion of each of said wall sections defines said outer contour.

39. The antenna mast arrangement of claim 38, wherein said at least one antenna, when connected to said attachment structure, is arranged between said first and said second wall sections.

40. The antenna mast arrangement of claim 39, wherein said outline element extends between said wall sections and radially outside said at least one antenna when connected to said attachment structure.

41. The antenna mast arrangement of claim 38, wherein at least one of said first and second wall sections is at least partially permeable to air in order to reduce wind resistance of said top section.

42. The antenna mast arrangement of claim 36, wherein said at least two contour elements each comprises a wire or has an elongated form similar to a wire.

43. The antenna mast arrangement of claim 36, wherein said top section comprises a lower module at said lower level and an upper module at said upper level, and wherein said lower module comprises a first circle sector which is adapted to comprise said at least one antenna of said first type and said upper module comprises a second circle sector which is adapted to comprise said at least one antenna of said second type, and wherein further said upper module is displaceable in a circumferential direction in relation to said lower module.

44. The antenna mast arrangement of claim 36, wherein at least one of said contour elements extends over said lower level only or over said upper level only.

45. The antenna mast arrangement of claim 36, wherein at least one of said contour elements extends over said lower level and said upper level.

46. The antenna mast arrangement of claim 36, wherein said top section comprises at least one discrete outline element extending substantially horizontally to define an outer contour of said top section.

47. The antenna mast arrangement of claim 46, wherein said outline element extends between said wall sections and radially outside said at least one antenna when connected to said attachment structure.

48. The antenna mast arrangement of claim 46, wherein said outline element has a curved shape.

49. The antenna mast arrangement of claim 36, wherein said contour elements or said outline element, or both, are illuminated.

50. The antenna mast arrangement of claim 36, wherein said contour elements or said outline element, or both, are provided with heating means for reducing collected ice or collected water, or both.

51. The antenna mast arrangement of claim 36, comprising a plurality of contour elements distributed circumferentially around said top section.

52. The antenna mast arrangement of claim 36, wherein said outer contour of said top section has a shape of a truncated cone with its narrow end adapted to adjoin said antenna mast body.

53. The antenna mast arrangement of claim 36, wherein said antenna mast arrangement is a tubular telecommunication tower and said antenna mast body is made from reinforced concrete.
